(19) United States
(12) Patent Application Publication
(10) Pub. No.: US 2004/0226649 A1
(43) Pub. Date: Nov. 18, 2004

(54) Buoyant balloons

(75) Inventors: Mark Van Dyke, Crete, IL (US); William Ward, Manteno, IL (US); Robert Schulteis, Manteno, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: M & D Balloons, Inc.

(21) Appl. No.: 10/818,134

(22) Filed: Apr. 5, 2004

Related U.S. Application Data
(63) Continuation of application No. 10/015,441, filed on Dec. 13, 2001, now abandoned.

(51) Int. Cl. A63H 3/06; B32B 31/20

(52) U.S. Cl. 156/219; 446/220; 156/308.4

(57) ABSTRACT

Buoyant balloons are provided with a texturizing layer which is operated upon with embossing or other techniques to provide interesting visual effects. The texturizing is formed on the outer surface of the texturizing layer, which is located on the outer surface of the balloon film. One or more ink coatings may be used in conjunction with the texturized balloon film to augment visual interest.

### BACKGROUND OF THE INVENTION

1. Field of the Invention

The present invention is directed to novelty balloons and in particular to novelty balloons which are made buoyant by filling with a lighter-than-air gas.

2. Description of the Related Art

Toy balloons made of transparent sides have long enjoyed popularity, and various arrangements for these balloons have been provided over the years. For example, British Patent No. 896,904 provides fluorescent or luminescent painted elements in association with an inflatable toy balloon of substantially transparent material. A combination of inner and outer balloons is also mentioned. Japanese Tokkai 1993-3970 discloses a clear film panel with interior and exterior images and back side coloring to provide a three-dimensional effect.

U.S. Pat. No. 5,338,243 discloses a balloon having a clear foreground side and a background side bearing a depiction of scenery or the like. A foreground depiction is also applied to the foreground sheet and, when viewed from a distance, the resulting balloon construction exhibits a type of three-dimensional characteristic. The balloon is filled with helium so as to render the balloon construction buoyant.

U.S. Pat. No. 2,927,383 discloses a spherical satellite mounted within an outer body of transparent material. U.S. Pat. No. 5,108,339 discloses an outer clear balloon surrounding an inner balloon. The resulting construction is filled with helium gas rendering the resulting combination the ability to freely float. U.S. Pat. No. 5,254,026 provides a transparent balloon having an internal pocket for holding a removable item, such as a photograph.

Despite the variety of balloons having one or more clear sides, there exists a demand for further variety and improvements. Improvements to non-clear, e.g., metalized, balloons are also being sought.

### SUMMARY OF THE INVENTION

It is an object of the present invention to provide a balloon having at least one clear side which exhibits an impermeability to lighter-than-air gases so as to render the balloon buoyant in air.

Another object of the present invention is to provide a balloon of the above-described type wherein the clear side is textured to add a visual effect.

Yet another object of the present invention is to provide texturing of a type which forms prismatic or holographic-like structures in the clear material. A related object of the present invention is to provide such holographic or prism-like structures in a clear film, exhibiting a barrier to lighter-than-air gases by embossing one or more layers of the film.

These and other objects of the present invention are provided in a method of making a clear buoyant balloon, comprising the steps of:

providing a base layer sufficient to contain a lighter-than-air gas for a pre-selected period of time;

providing the base layer with a first surface portion for heat sealing and a second opposed surface portion;

adhering a texture layer of pre-selected hardness to the second, opposed surface portion of the base layer;

forming micro-structures in the texture layer for reflecting and refracting light;

said base layer and said embossing layer selected from clear materials which are either translucent, transparent, or both;

joining the texturing layer to the base layer so as to form a balloon film;

overlaying two portions of said balloon film in registry, with the heat sealing surface portions of said balloon film portions in contact with one another; and

heat sealing said balloon film portions together so as to form a pressure-tight vessel for a lighter-than-air gas.

### BRIEF DESCRIPTION OF THE DRAWINGS

FIG. 1 is a fragmentary top plan view of a balloon, shown partly broken away, constructed according to principles of the present invention;

FIG. 2 is a cross-sectional view taken along the line 2-2 of FIG. 2;

FIG. 3 is a fragmentary cross-sectional view taken along the line 3-3 of FIG. 2; and

FIGS. 4-9 show alternative constructions of the balloon film of FIG. 3.

### DETAILED DESCRIPTION OF THE PREFERRED EMBODIMENTS

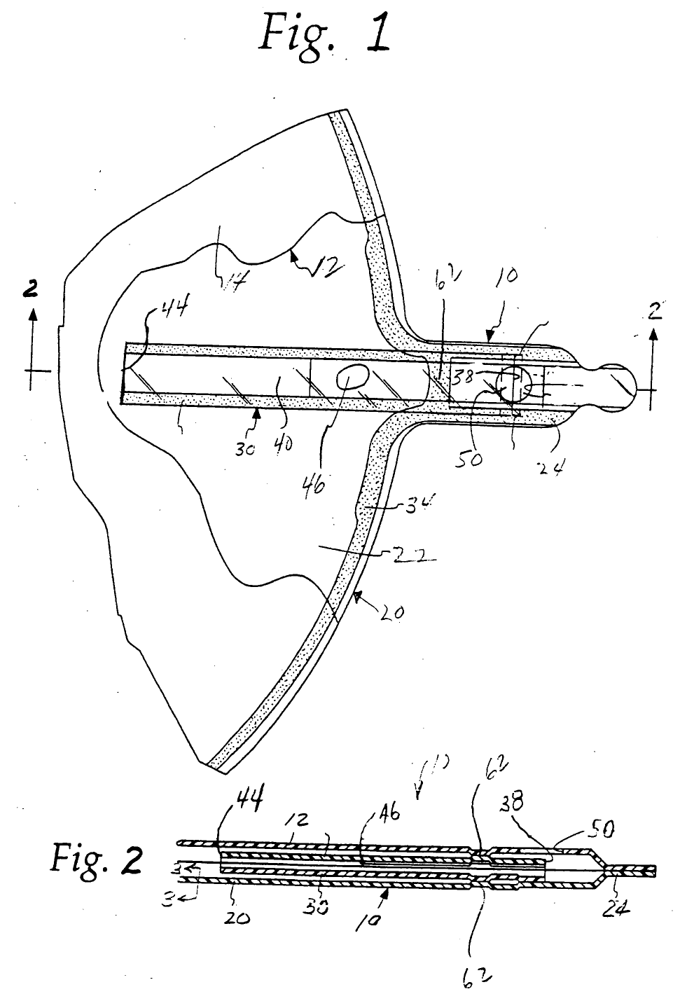

Referring now to the drawings, and initially to FIGS. 1-3, a balloon assembly is generally indicated at 10. Balloon assembly 10 includes an upper balloon film 12 having a body portion 14 and a neck portion (not shown). A bottom balloon film layer 20 has a body portion 22 and a neck portion 24. According to one aspect of this embodiment, at least one of the balloon film layers 12, 20 is substantially clear, either transparent or translucent. A valve 30 of conventional construction is placed between the upper and lower balloon films 12, 20, and the upper and lower balloon films and the valve are sealed at 34 using conventional heat sealing techniques to form a pressure-tight vessel.

Valve 30 includes an inlet end 38 at which a pressurized gas is introduced to fill the interior of the balloon. The pressurized gas travels along a valve passageway 40, exiting at a free end 44 of the valve. A conventional sealing-preventing barrier layer 46 lies underneath a hole 50 formed in the upper valve layer. It is important that the balloon film layers be compatible with conventional heat sealing techniques as well a with conventional valve materials. For example, referring to FIG. 2, balloon films 12, 20 are joined at heat seal 62 to respective layers of valve 30, one of the critical areas in which an intimate pressure-tight seal is required to ensure that the balloon assembly will function in a satisfactory manner.

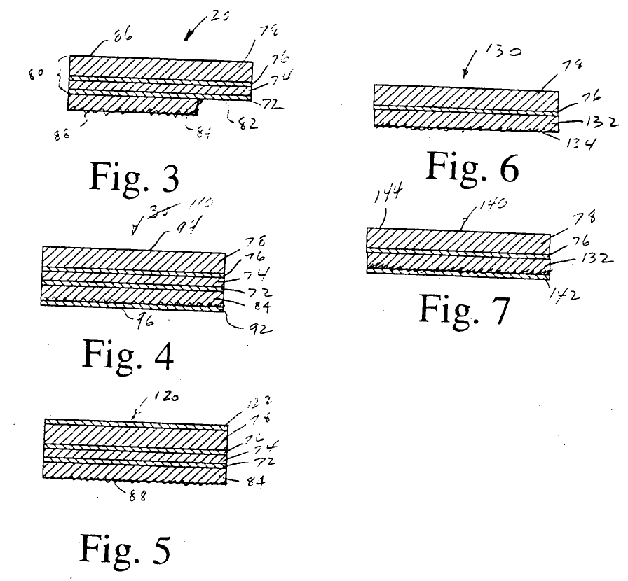

Turning now to FIG. 3, a cross-section of the lower balloon film 20 is shown on an enlarged scale. As will be seen, the balloon film is comprised mostly of a composite base layer. The composite base layer preferably is formed of a clear laminate film comprising one or more polymeric layers. The thickness of the composite base film is not critical to the present invention and can be selected appropriately in consideration of the desired balloon buoyancy, given the internal volume of the balloon vessel and the type of lighter-than-air gas employed. By employing the present invention, properties of the underlying barrier composite film are maintained in a manner consistent with high transparency and clear visual accessibility to visual effects appearing on both opposed balloon films forming the pressure-tight balloon vessel. A layer 72 is preferably comprised of nylon material and, in one embodiment, has a thickness of approximately 3 microns. A barrier layer 74 of conventional EVOH material is bonded to the nylon layer 72 and a second nylon layer 76 is bonded to the remaining open face of EVOH layer 74. Finally, a polyethylene layer 78, having an approximate thickness of 13 microns, is sealed to the remaining face of nylon layer 76.

The layers 72-78 may be applied directly one to the other to form a composite base film 80. As an alternative, the layers 72-78 of arbitrary, pre-set thickness and treatment may be obtained in a preassembled unitary composite film commercially available under the trade designation Gunze 525 Heptax and may be used as a basis for forming balloon layers 12, 20. The polyethylene layer 78 forms the “inner” surface of the composite film, and is arranged to face the interior of the balloon cavity. In the preferred embodiment, balloon layers 12, 20 are of identical construction, although, if desired, the balloon film base layers could take on virtually any construction known today, including those constructions which are not specifically designed to provide a barrier to a lighter-than-air gas, such as helium.

According to one aspect of the present invention, a texturing layer 84 is applied to the exposed surface 82 of the nylon base layer 72. Various materials for texturing layer 84 include harder layers of acrylics, nitrocellulose, polyamide, conventional varnishes with different base resins, as well as softer layers, such as those made of polyesters, polyethylene or additional layers of nylon. It is preferred that texturing layer 84 be made of harder materials commercially available, because of their ability to retain a higher resolution of physical detail. Of the harder materials, acrylic is the most preferred. According to the present invention, the composite base film 80 may also be regarded as a barrier composite film, since it includes a layer sufficient to contain lighter-than-air gas, such as helium. According to one principal of the present invention, the texturizing layer protects the underlying composite base film, preventing deterioration of gas containment properties (even when external mechanical forces such as embossing are employed for texturizing) so as to avoid exposing the resulting balloon film to micro-leakage conditions even when the balloon is inflated with lighter-than-air gas to maximum pressures.

The film construction illustrated in FIG. 3 is made to undergo a texturing, preferably an embossing process, with mechanical work being performed on the exposed surface of texturing layer 84, so as to form light-reflecting and/or light-refracting micro-structures. In the preferred embodiment, the embossing step is carried out according to the “holographic” embossing process commercially available from SpectraTec Technologies, Inc., of Los Angeles, Calif., which provides more finely detailed structures.

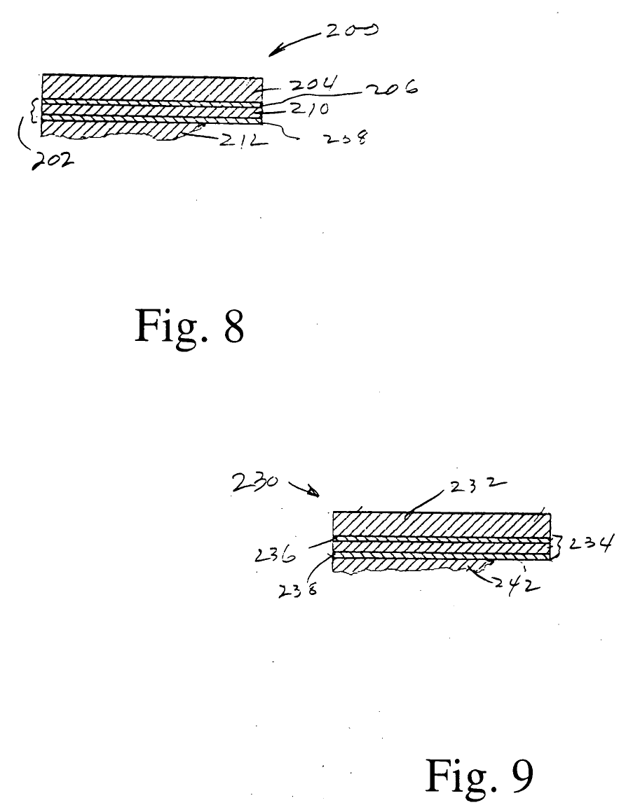

As can be seen in FIG. 3, the layers 72-78 together comprise the composite base film 80 to which the texturing layer 84 is applied. One embodiment, the composite base film, is commercially obtained in a pre-fabricated condition, under the trade designation Gunze 525 Heptax. Other composite base films, such as those shown in FIGS. 8 and 9, may also be used.

Turning now to FIG. 8, a balloon film 200 includes a composite base film 202 to which a polyethylene sealant layer 204 is applied, so as to face the balloon cavity. Nylon layers 206, 208 are located on either side of a barrier layer 210. Most preferably, barrier layer 210 is made of EVOH material having a thickness of 3 microns, and the nylon layers 206, 208 have a thickness of 6 microns. Texturing layer 212 is provided, as shown, in conjunction with the aforementioned commercial SpectraTec embossing process. The composite base film 202 may be assembled layer by layer, or may be commercially obtained as Gunze 315 N film.

Turning now to FIG. 9, a balloon film 230 includes a polyethylene layer 232 applied to a composite base film 234. Nylon layers 236, 238 of five micron thickness are located on either side of an EVOH layer, also of 5 micron thickness. A texturing layer 242 is also included. The composite base film 234 may be commercially obtained as Gunze 315 E film.

As mentioned above, with respect to various embodiments, a texturizing layer may be applied for a subsequent embossing step. If desired, the texturizing layer may be made of a variety of materials. In order to provide commercially attractive embossing patterns, it is generally preferable that the texturizing layer be made of a relatively hard material such as acrylic. While an acrylic coating can be economically applied using conventional techniques, the balloon film must be fully processed in a relatively prompt fashion in order to avoid adhesion problems in subsequent balloon manufacturing steps. For example, waxy materials and stabilizing agents commonly used to fabricate the polyethylene sealant coating tend to bloom to the coating surface, so as to be transferred to opposing surfaces of the balloon film as the film is rolled for transport or temporary storage. Surface adhesion problems were found to occur if the partially completed balloon film remained rolled for periods ranging between two to 3 months. As an ameliorating step, commercially available adhesion coatings, such as a Honeywell “M coating,” may be applied before further processing of the balloon film is carried out. Further processing of the balloon film may comprise, for example, the aforementioned commercial SpectraTec embossing process which is believed to apply, in some instances, an additional embossing layer to the balloon film.

The following is a description of two examples of balloon film prepared according to principles of the present invention, along with a description of the preferred Gunze 525 Heptax base layer. Both examples given herein comprise embossing layers formed on the same base layer, Gunze 525 Heptax film having a weight of 0.2705 grams per 4″ by 4″ section, 16.101 lbs. per ream and 26,830 sq. inches per pound. In a first example, a balloon film was constructed by coating the base layer with the aforementioned acrylic product CHIFW 0830229 from Sun Chemical at a rate of 21 seconds, using a number 2 Zahn cup. This yielded a balloon film having a weight of 0.2796 grams per 4″ by 4″ section, 16.642 lbs. per ream and 25,958 sq. inches per pound. In a second example, a balloon film was constructed by coating the Gunze 525 Heptax base film with a coating of acrylic product CHIFW 0830229 from Sun Chemical at a rate of 30 seconds, using a number 2 Zahn cup. This produced a balloon film weighing 0.2921 grams per 4″ by 4″ section, 17.386 lbs. per ream and 24,847 sq. inches per pound.

Those skilled in the art have sought to improve the visual characteristics of the composite base films. According to principles of the present invention, such improvements are provided by coating the composite base film with a texturing layer. Preferably, the texturing layer is chosen so as to exhibit the desired hardness sufficient to obtain the micro-structure resolution desired, when the outer exposed surface of the texturizing layer is operated upon to form light reflecting and refracting structures.

The preferred type of buoyant balloon film product contemplated by the present invention is capable of sustaining working gas pressures for a number of days after inflation. This requires that the gas barrier (e.g., EVOH) layer 74 not be degraded during texturizing. It is important in this regard that embossing or other texturizing devices penetrating the texturizing layer 84 do not exert pressures through nylon layer 72 which would exhibit localized force concentrations on EVOH layer 74, which would, during the working life of the balloon, cause a crack or defect in the EVOH layer, thus reducing its barrier performance. As a related problem, embossing, tooling or the like texturing devices, are not allowed to penetrate the nylon layer 72, so as to expose portions of the EVOH layer 74 to ambient humidity, thus leading to deterioration of the EVOH barrier properties. Other concerns of this type mandate that the lamination of the texturizing layer 84 to nylon layer 72 be carried out using conventional dry lamination processes to avoid trapping moisture on either side of the EVOH layer 74.

The barrier layer 74, in addition to EVOH material, may comprise other conventional materials, including PVC materials as SARAN, as such, as well as, materials described in Japanese Patent Application Laid Open No. 173137/1992 (JP-A-4-173137). Examples include a two-part polyurethane film, an inorganic oxide, thin-layer, a vinyl chloride/vinyl acetate co-polymer and other materials.

Referring now to FIG. 4, an alternative balloon layer 30 is substantially identical to the balloon layer 20 described above, but has an additional outer layer 92 comprising a conventional ink coating applied to the exposed surface 88 of texturing layer 84. Ink layer 92 can be of any type commercially available which is compatible with the composition of the texturing layer and which is capable of allowing light reflections from the surface micro-structures formed by the texturing process to exhibit the desired visual effect when exposed to incident illumination from either the internal surface 94 or the external surface 96 of layer 30.

Turning again to FIG. 3, it is generally preferred that the composite base film 80 be substantially clear, that is, transparent or translucent, such that light incident on the inner face 86 reaches the texture micro-structures formed in outer surface 88, so as to provide light exiting outer surface 88 with the desired visual effect. It is most preferred that light entering the viewed surface of the balloon be refracted and reflected to some extent by the viewed balloon film, and that the light also be refracted and reflected by the opposed balloon film, so as to also be visible through the viewed balloon film. For example, with the preferred form of texturing, i.e., embossing according to the “holographic” commercial process offered by SpectraTec, a high density of finely detailed micro-structures are embossed in the outer surface 88. Light entering from outside the balloon, so as to be incident on the outer surface 88, causes a portion of the light entering the textured surface to be reflected back to a viewer.

It is also important that a portion of the light pass through the balloon interior, so as to enter the interior surface of the remaining side of the balloon. This light passes through the composite base film 80 and texturing layer 84, so as to be incident on the back surfaces of micro-structures formed in the layer's outer surface 88. This incident light passing through the balloon interior is refracted by the micro-structures before reaching a viewer observing the textured surface 88.

Referring now to FIG. 5, a balloon layer 120 is substantially identical to the balloon layer 20 described above, but with the addition of an ink coating 122 applied to the inner exposed surface of layer 78. Again, virtually any conventional ink may be used to form layer 122. If desired, the ink layer may be applied directly to the exposed surface of layer 78 with or without conventional pre-treatment of the exposed surface, such as treatment of the corona discharge, plasma, glow discharge, reverse sputter, flame, chromic acid, solvent or surface roughening type. It is generally preferred that an undercoat layer not be employed between ink layer 122 and layer 78. This allows the ink coating to exhibit sufficient translucence, allowing substantial light passage through outer surface 88 to a distant viewer.

Balloon films mentioned above include a helium barrier layer of conventional EVOH material. Such balloons provide a commercially significant retention period for pressurized helium contained within the balloon vessel. Such “class 1” buoyant balloons filled with helium or other lighter-than-air gas, maintain working pressures, once filled and left unattended, for 4-5 days.

At times, balloons are required to have only a much shorter service life, on the order of 8 to 24 hours. Such “class 2” helium balloons are adequate to maintain helium or other lighter-than-air gas pressures for this shortened time duration. An example of such “class 2” helium balloon layers according to principles of the present invention is shown in FIG. 6. A polyethylene or other heat sealant material is formed on nylon layer 76 as an adjoining layer 78. A texturing layer 132 is then joined to nylon layer 76 to form the resulting balloon layer 130. The outer, exposed surface 134 of balloon layer 130 is then treated in a texturizing manner, such as the preferred texturizing treatment carried out according to the “holographic” process commercially available from SpectraTec, Inc. As with the preceding embodiment, construction of balloon layer 130 is carefully carried out so as to minimize any inter-layer light blockage which might lessen the desired “dazzle” or other visual effect.

With either class of buoyant balloon, the material hardness and thickness of the texturizing layer is matched to the depth of material displacement caused during texturizing and to the transmission of forces within the overall balloon film, which might distort underlying film layers. Matching is performed such that heat sealing of the balloon film layer can be carried out using conventional techniques to achieve commercial inflation standards for buoyant balloons. In particular, it has been found that by carrying out balloon construction according to principles of the present invention, so-called micro-leaks or very slow leaks of helium-filled balloons are effectively prevented. The use of texturized films, such as those produced by embossing, has heretofore been limited to balloons utilizing metalized films which offer a greater structural strength, but which do not allow see-through characteristics of clear balloon films.

Referring now to FIG. 7, balloon film 140 is substantially identical to balloon film 130, but for an added ink coating layer 142. If desired, the ink coating 142 could be applied to the inner surface 144.

The drawings and the foregoing descriptions are not intended to represent the only forms of the invention in regard to the details of its construction and manner of operation. Changes in form and in the proportion of parts, as well as the substitution of equivalents, are contemplated as circumstances may suggest or render expedient; and although specific terms have been employed, they are intended in a generic and descriptive sense only and not for the purposes of limitation, the scope of the invention being delineated by the following claims.

What is claimed is:

1. A method of making a clear buoyant balloon, comprising the steps of:
providing a base layer sufficient to contain a lighter-than-air gas for a pre-selected period of time;
providing the base layer with a first surface portion for heat sealing and a second opposed surface portion;
adhering a texture layer of pre-selected hardness to the second, opposed surface portion of the base layer;
forming micro-structures in the texture layer for reflecting and refracting light;
said base layer and said embossing layer selected from clear materials which are either translucent, transparent, or both;
joining the texturing layer to the base layer so as to form a balloon film;
overlaying the two portions of said balloon film in registry, with the heat sealing surface portions of said balloon film portions in contact with one another; and
heat sealing said balloon film portions together so as to form a pressure-tight vessel for a lighter-than-air gas.

2. The method according to claim 1 wherein said lighter-than-air gas comprises helium.

3. The method according to claim 1 wherein said step of forming said micro-structures are carried out by embossing said micro-structures into said texturing layer.

4. The method according to claim 1 wherein said texturing layer is formed of acrylic material.

5. The method according to claim 1 wherein said base film includes a barrier to said lighter-than-air gas.

6. The method according to claim 5 wherein said base film comprises commercial Gunze 525 Heptax film.

7. The method according to claim 5 wherein said base film comprises commercial Gunze 315 N film.

8. The method according to claim 5 wherein said base film comprises commercial Gunze 315 E film.

9. The method according to claim 1 wherein said base layer comprises a nylon layer joined to a layer of heat sealant material.

10. The method according to claim 9 wherein said heat sealant material comprises polyethylene.

11. The method according to claim 1 further comprising the step of applying an ink coating to part of the heat sealing surface portion.

12. A method of providing a balloon film used to form a clear, buoyant lighter-than-air balloon having improved visual properties, comprising the steps of:
providing a base layer sufficient to contain a lighter-than-air gas for a pre-selected period of time;
providing the base layer with a first surface for heat sealing and a second opposed surface;
adhering to the second, opposed surface of the base layer a texture layer of pre-selected hardness;
forming micro-structures in the texture layer for reflecting and refracting light;
said base layer and said embossing layer selected from clear materials which are either translucent, transparent, or both; and
joining the texturing layer to the base layer so as to form a balloon film.

13. The method according to claim 12 wherein said lighter-than-air gas comprises helium.

14. The method according to claim 12 wherein said step of forming said micro-structures are carried out by embossing said micro-structures into said texturing layer.

15. The method according to claim 12 wherein said texturing layer is formed of acrylic material.

16. The method according to claim 12 wherein said base film includes a barrier to said lighter-than-air gas.

17. The method according to claim 16 wherein said base film includes Gunze 525 Heptax film.

18. The method according to claim 16 wherein said base film includes EVOH film.
